(19) United States
(12) Patent Application Publication
(10) Pub. No.: US 2026/0350866 A1
(43) Pub. Date: Nov. 5, 2026

(54) BRANCHED NARRATIVE FICTION VISUALIZATIONS FOR AUTHORING EMERGENT NARRATIVES USING LARGE LANGUAGE MODELS

(71) Applicant: AUTODESK, INC., San Francisco, CA (US)

(72) Inventors: Frederik BRUDY, Toronto (CA); Aditi MISHRA, San Francisco, CA (US); Fraser ANDERSON, Newmarket (CA); Qian ZHOU, San Francisco, CA (US); George William FITZMAURICE, Toronto (CA)

(21) Appl. No.: 19/291,428

(22) Filed: Aug. 5, 2025

Related U.S. Application Data
(60) Provisional application No. 63/799,302, filed on May 2, 2025.

(51) Int. Cl. G06T 11/26

(52) U.S. Cl. CPC G06T 11/26; G06T 2200/24

(57) ABSTRACT

One embodiment sets forth a technique for developing branched narrative fictions. According to some embodiments, the method can include receiving input data comprising narrative content; generating, via a generative artificial intelligence (AI) model, a narrative graph based on the input data, where the narrative graph comprises a plurality of events; receiving a selection of an event within the narrative graph; generating an updated version of the narrative graph based on the event; and displaying, via a user interface, a representation of the updated version of the narrative graph.

### CROSS-REFERENCE TO RELATED APPLICATIONS

The present application claims the benefit of U.S. Provisional Application titled, “TECHNIQUES FOR IMPLEMENTING BRANCHED NARRATIVE FICTION VISUALIZATIONS FOR AUTHORING EMERGENT NARRATIVES USING LARGE LANGUAGE MODELS,” filed on May 02, 2025, and having Serial No. 63/799,302. The subject matter of this related application is hereby incorporated herein by reference.

### BACKGROUND

### FIELD OF THE VARIOUS EMBODIMENTS

Embodiments of the present disclosure relate generally to computer science, artificial intelligence, and complex software and, more specifically, to branched narrative fiction visualizations for authoring emergent narratives using large language models (LLMs).

### DESCRIPTION OF THE RELATED ART

A branched narrative fiction (BNF) represents a storytelling method in which the narrative of a story can split into multiple branching storylines based on choices made by a player. Rather than adhering to a single linear storyline, the narrative structure of BNF contains branches that diverge at particular events, thereby leading to branching storylines. The player becomes an active participant in the plot by selecting an outcome or progression of the plot at various specific diverging events. Examples of BNF media include, but are not limited to, video games, choose-your-own-adventure books, interactive visual novels, and tabletop role-playing games.

Authoring BNF to develop a narrative structure with multiple branching storylines requires significant organization. Authors must ensure that each branching storyline remains narratively coherent and meaningful. As narrative complexity increases, managing structure, continuity, and dependencies without a structure to modify the narrative structure across all branching storylines becomes unfeasible. Traditional approaches to authoring branched narrative fictions involve software platforms that often require the use of scripting languages and a predetermined narrative structure established at the time of creation.

One drawback of conventional software platforms is the requirement to use scripting or markup languages, which can create a difficult learning curve for beginner users of the software platform. As a result, users may allocate significant time to learning technical syntax rather than focusing on authoring the multiple branching storylines. Additionally, conventional software platforms are typically employed after the narrative structure is established. Consequently, conventional software platforms require a static narrative structure that cannot be easily modified as the user authors or modifies additional branching storylines. In this regard, the static narrative structure hinders experimentation and consumes significant time when modifications or additions to existing branching storylines are required in response to creative changes or new ideas.

As the foregoing illustrates, what is needed in the art are more effective techniques for generating and organizing branched narrative fictions.

### SUMMARY

One embodiment sets forth a method for developing branched narrative fictions. According to some embodiments, the method can include receiving input data comprising narrative content; generating, via a generative artificial intelligence (AI) model, a narrative graph based on the input data, where the narrative graph comprises a plurality of events; receiving a selection of an event within the narrative graph; generating an updated version of the narrative graph based on the event; and displaying, via a user interface, a representation of the updated version of the narrative graph.

At least one technical advantage of the disclosed techniques over prior approaches is the provision of a visual, intuitive, and interactive software platform that leverages generative artificial intelligence (AI) to facilitate organization, development, and exploration of branched narrative fictions. The software platform enables multiple branching storylines to be dynamically edited, rearranged, and analyzed in parallel. Such functionality is supported, in part, by a graph-based representation of branching structures – referred to as a narrative graph – that captures relationships among events, characters, locations, actions, and narrative outcomes. Maintenance and visualization of such relationships improves the ability to manage and navigate complex, branching storylines.

In addition to enhanced organizational capabilities, the disclosed techniques can reduce the time and effort required to author and revise branched narrative fiction by eliminating reliance on manual scripting or specialized markup languages. Instead, branching storylines can be generated and refined through direct manipulation of specific events, with generative suggestions accelerating the development process. The ability to generate and manage a larger number of narrative branches provides a broader range of options for each storyline, thereby contributing to higher-quality creative outputs. Use of narrative graphs further supports iterative refinement and enables validation of thematic structure and consistency across branching paths, thereby enhancing overall narrative coherence.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of various embodiments.

FIG. 2 illustrates a detailed view of the software application of FIG. 1, according to various embodiments.

FIG. 3 illustrates an example workflow diagram for generating and organizing branched narrative fictions, according to various embodiments.

FIG. 4 illustrates conceptual diagrams of user interfaces associated with a software application executing on one of the endpoint devices of FIG. 1, according to various embodiments.

FIG. 5 is a detailed illustration of an event, according to various embodiments.

FIG. 6 is a detailed illustration of a mood blender, according to various embodiments.

FIG. 7 sets forth a flow diagram of method steps for generating and displaying a narrative graph from a seed input, according to various embodiments.

FIG. 8 sets forth a flow diagram of method steps for generating new events within a narrative graph, according to various embodiments.

FIG. 9 sets forth a flow diagram of method steps for verifying continuity and consistency of a narrative graph, according to various embodiments.

FIG. 10 sets forth a flow diagram of method steps for evaluating a narrative graph based on user-defined metrics, according to various embodiments.

FIG. 11 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

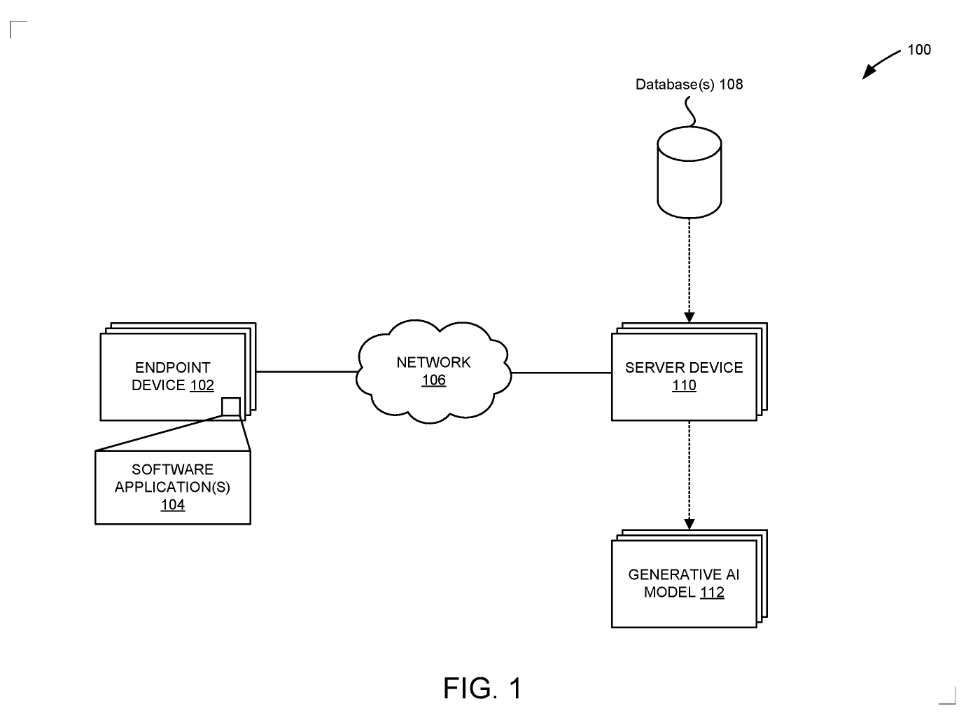

FIG. 1 is a block diagram of a system 100 configured to implement one or more aspects of the various embodiments. As shown, the system 100 includes at least one endpoint device 102, at least one server device 110, at least one database 108, and at least one generative AI model 112, which can communicate with one another via a communications network 106. The communications network 106 can represent any technically feasible network or combination thereof, including a wide area network (WAN) such as the Internet, a local area network (LAN), a Wi-Fi network, or a cellular network.

According to some embodiments, an endpoint device 102 can represent a computing device, such as a desktop computing device, a laptop computing device, or a mobile computing device. As shown in FIG. 1, at least one software application 104 can be installed and executed on the endpoint device 102. The software application 104 can represent a web browser application, a web browser application extension, or a productivity application that enables the generation and organization of branched narrative fictions in accordance with the techniques described herein. For instance, the software application 104 can generate and modify branching storylines that are part of a branched narrative fiction.

According to some embodiments, the software application 104 can be configured to facilitate data collections and user interactions to enable the software application 104 and the server device 110 to implement the various techniques described herein. In particular, the software application 104 can collect and transmit input data required by the server device 110. The server device 110 can then transmit output data to the software application 104. The software application 104 can display the output data and enable user interaction with the output data through one or more user interfaces. It should be appreciated that, in some embodiments, the software application 104 can implement the techniques described herein independently from the server device 110, consistent with the scope of this disclosure. As described herein, the software application 104 and the server device 110 can enable users to generate and organize branched narrative fictions.

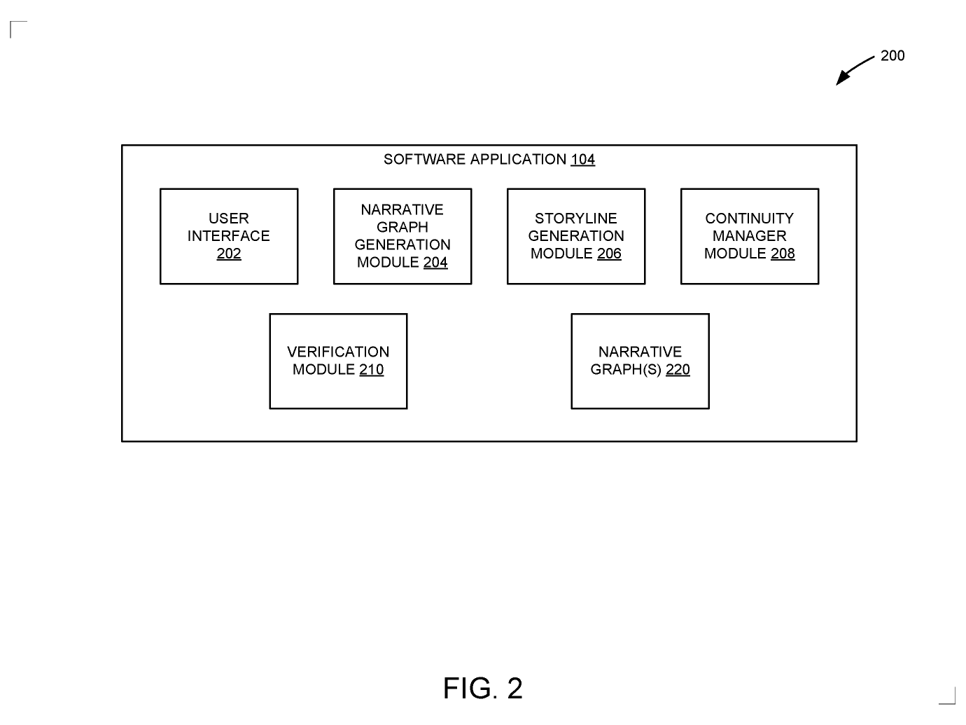

According to some embodiments, the generative AI models 112 can represent one or more trained machine learning models. For example, the generative AI models 112 can be implemented as large language models, computer vision models, graph neural networks, or other advanced architectures. As described in greater detail below in conjunction with FIGS. 2-10, the generative AI models 112 can be trained to generate narrative graphs, generate alternative diverging storylines, generate sequential storyline events, verify continuity within branches, verify branches based on user-defined metrics, and perform various other operations. The generative AI models 112 can also be configured to convert abstract data types between different formats.

FIG. 2 illustrates a detailed view 200 of the software application 104 of FIG. 1, according to various embodiments. As shown in FIG. 2, the software application 104 includes a user interface 202, a narrative graph generation module 204, a storyline generation module 206, a continuity manager 208, a verification module 210, and one or more narrative graphs 220.

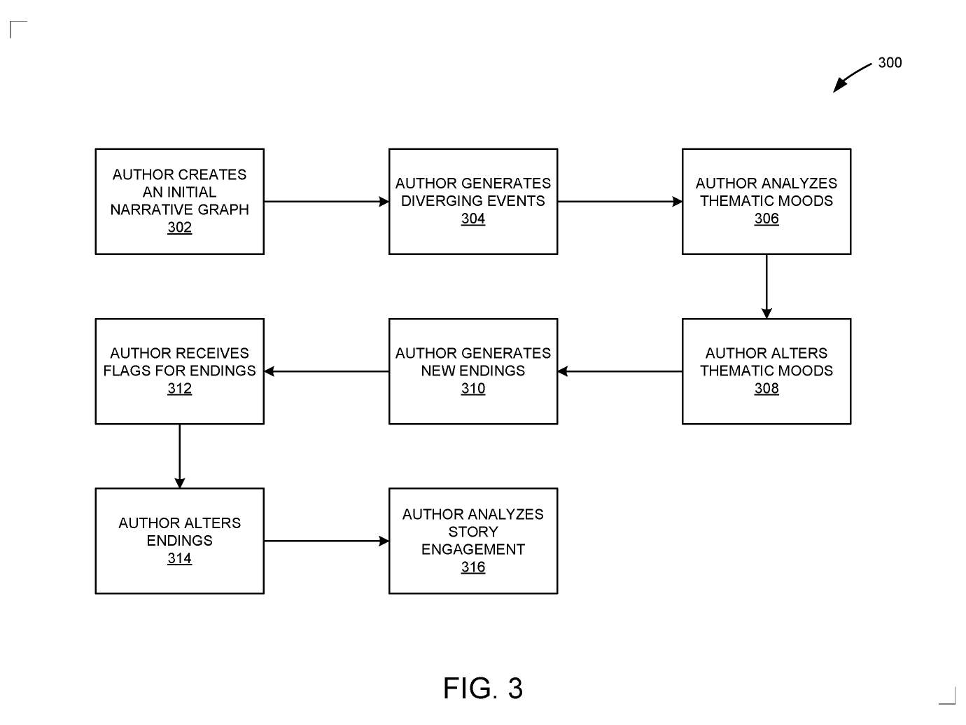

According to some embodiments, the user interface 202 provides input controls and outputs visualizations to perform branched narrative fiction authoring. In particular, the user interface 202 allows user interaction with the software application 104 and modifications to the narrative graph 220 (discussed further below) through any feasible input device (not shown). The user interface 202 outputs information through a display. The user interface 202 accepts user inputs and forwards instructions to the narrative graph generation module 204, the storyline generation module 206, the continuity manager 208, and the verification module 210, in accordance with the techniques described herein. Specific elements of the user interface 202 are discussed further in conjunction with FIGS. 3-6.

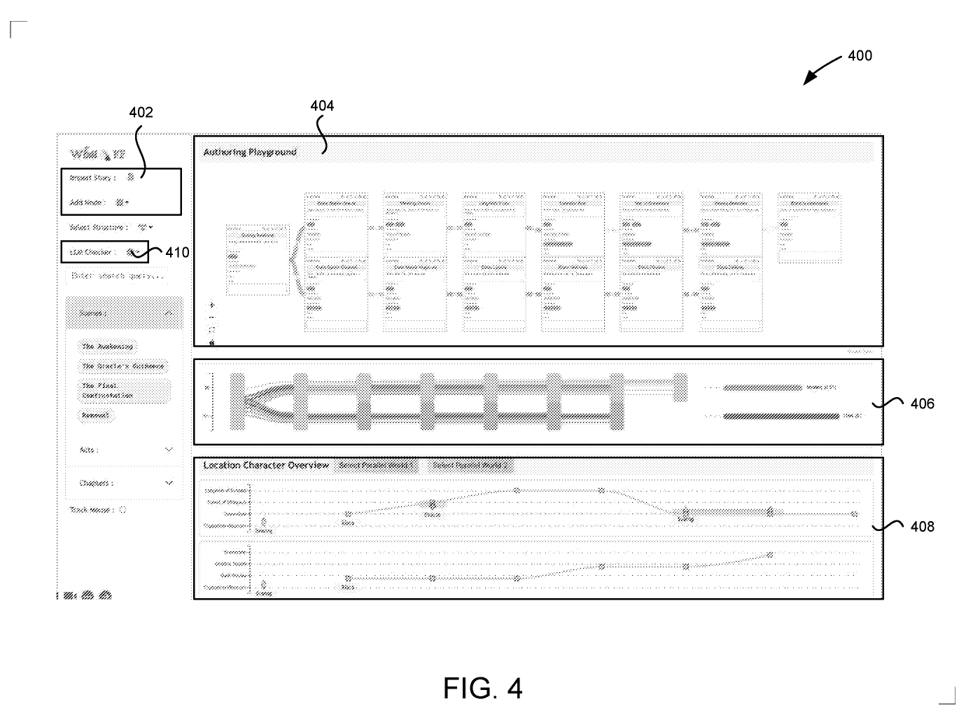

According to some embodiments, the narrative graph generation module 204 can receive a seed input (discussed below) and utilize the generative AI model 112 to generate the narrative graph 220 based at least in part on the seed input. According to some embodiments, the narrative graph 220 represents a data structure that includes events (among other elements). According to some embodiments, events are data structures that include fields for event information (e.g., descriptions of an event), event metadata such as character identifiers, location identifiers, setting identifiers, mood tags, and other information. According to some embodiments, events are ordered according to narrative time within the narrative graph 220. According to some embodiments, the narrative graph 220 supports the representation of multiple branching storylines and enables traversal of narrative paths for generation and verification. The narrative graph 220 and events are further discussed in detail in conjunction with FIGS. 4-6.

As a brief aside, it should be appreciated that the narrative graphs 220 described herein are not limited to being generated by artificial intelligence or automated processes. In some implementations, the software application 104 can enable a user to generate a given narrative graph 220 through manual or semi-automated interactions with various user interfaces, such as graphical editors, form-based input tools, drag-and-drop frameworks, or scripting environments. For example, the user may construct a narrative graph 220 node-by-node and define edges between nodes to represent narrative paths, causal relationships, or temporal sequences. In other scenarios, the software application 104 may provide predefined templates or reusable components that the user can configure and assemble into a complete narrative graph 220. Additionally, the user may import an externally created narrative graph 220 into the software application 104 from other software tools, file formats, or data sources, such as JSON files, XML documents, spreadsheet representations, third-party graph databases, or external content design systems. The narrative graph 220 may also be the product of a hybrid process, in which portions of the graph are generated using AI models while others are authored or modified manually by the user. Furthermore, the software application 104 may support programmatic access to narrative graphs 220 via an application programming interface (API) to enable integration with external authoring pipelines or collaborative editing environments. Accordingly, the narrative graphs 220 as described herein are intended to encompass narrative graphs generated fully or partially by a user, by third-party systems, or through any suitable combination of manual, automated, and AI-based techniques.

Returning now to FIG. 2, according to some embodiments, the seed input can include narrative text that defines or describes an initial storyline. The seed input can further include one or more branching storylines or an outline describing one or more branching storylines. According to some embodiments, the seed input can include text describing or defining events, settings, characters, and initial mood parameters.

In operation, the narrative graph generation module 204 invokes the generative AI model 112 to segment the seed input into events. The narrative graph generation module 204 can then extract metadata for each event, such as characters, locations, narrative time index, and initial mood parameters. After events are generated, the narrative graph generation module 204 can link the generated events based on the narrative time index to create the narrative graph 220.

The storyline generation module 206, via generative AI model 112, can generate multiple sequential events or multiple diverging events based on a selected event and narrative context. In operation, the storyline generation module 206 receives a selected event, for example within a narrative graph 220, and associated narrative context, for example all previous events in the narrative graph 220. The storyline generation module 206 constructs a prompt for the generative AI model 112 specifying continuation or divergence of a storyline. The storyline generation module 206 then invokes the generative AI model 112 to generate one or more sequential or diverging events and inserts the generated events into the narrative graph 220. The operation of storyline generation module 206 is further described in detail in conjunction with FIGS. 3-6.

According to some embodiments, the continuity manager module 208 analyzes the narrative graph 220 after an addition, modification, or deletion of events and checks for continuity and consistency. The continuity manager module 208 iterates through each branching storyline and applies rule-based checks against the narrative graph 220 via the generative AI model 112, checking for continuity such as character existence, setting consistency, and narrative time ordering. The continuity manager module 208 can flag discontinuities associated with the narrative graph 220, (e.g., use-after-death of a character, contradictory location assignments, or timeline violations).

According to some embodiments, the continuity manager module 208 can also check for consistency of the narrative graph 220, such as lacking character interaction depth, frequently changing moods within a single storyline branch (defined directly below), and events or storyline branches with inconsistent pacing or lacking tension. In another embodiment, the continuity manager module 208 can identify potentially anticlimactic events by comparing event buildup against resolution depth. For example, if multiple consecutive events within a storyline branch have rising tension or intensity, contain significant action, or are associated with a mood, and a specific event in the sequence does not, the continuity manager module 208 can detect the lacking action, lacking resolution, or the sharp change in mood and flag the storyline branch. The continuity manager module 208 displays flagged items via the user interface 202 and can reflect resolved items after the user implements corrections to the narrative graph 220.

A storyline branch (or branch) is a path through a narrative graph 220 that begins directly prior to a root event and follows one or more edges to a terminal event. A storyline branch can include a sequence of events linked by edges that represent narrative progression. Storyline branches include references to character identifiers, location identifiers, and mood tags and can change through narrative time through progression of the storyline branch. Storyline branch traversal enables extraction of event sequences for generation, visualization, or verification.

According to some embodiments, the verification module 210 receives one or more branching storylines and a user-defined metric definition. The verification module 210 constructs a prompt for the generative AI model 112 that can specify evaluation of narrative coherence, engagement, or other user-defined metrics provided by a user of the software application 104. The verification module 210 invokes the generative AI model 112 and receives a response containing evaluation scores. The verification module 210 then parses the response to extract numeric scores for each branching storyline and can visualize the numeric scores for each branching storyline through the user interface 202.

FIG. 3 illustrates an example workflow diagram 300 for generating and organizing branched narrative fictions, according to various embodiments. The steps illustrate the execution of an embodiment of the software application 104 as a user, herein referred to as an author, interacts with the software application 104.

The steps are as follows. The software application 104 creates an initial narrative graph 302, the software application 104 generates diverging events 304, the software application 104 analyzes thematic moods 306, the software application 104 enables the altering of thematic moods 308, the software application 104 generates new endings 310, the software application 104 flags endings 312, the software application 104 alters endings 314, and the software application 104 analyzes story engagement 316.

The discussion of FIG. 3 references FIGS. 4-6 to identify requests received by the software application 104 as the author interacts with specific user interface elements. The following description alternates between steps in FIG. 3 and the corresponding user interface 202 elements shown in FIGS. 4-6. FIG. 4 illustrates conceptual diagrams of user interfaces 400 associated with a software application executing on one of the endpoint devices of FIG. 1, according to various embodiments.

The software application 104 creates an initial narrative graph 220 by receiving a seed input from the author. The narrative graph generation module 204 extracts information from the seed input to generate events, forming an initial narrative graph 220 that represents the key plot points. The narrative graph generation module 204, via the generative AI model 112, extracts metadata for each event, including character identifiers, location identifiers, and mood tags. The user interface 202 includes a visualization of the narrative graph 220 in an authoring panel 404, discussed directly below, to enable further interaction.

In operation, located in FIG. 4, the user interface panel 402 receives a selection by the author through the “import story” button. The user interface panel 402 enables the seed input to be imported and the narrative graph 220 generated via the narrative graph generation module 204. In some embodiments, the narrative graph 220 is generated and visualized through the user interface 202 within an authoring panel 404, a “mood river” visualization 406, and/or a location character overview 408. The user interface panel 402 supports manual addition of events to the narrative graph 220 through the “add node” button.

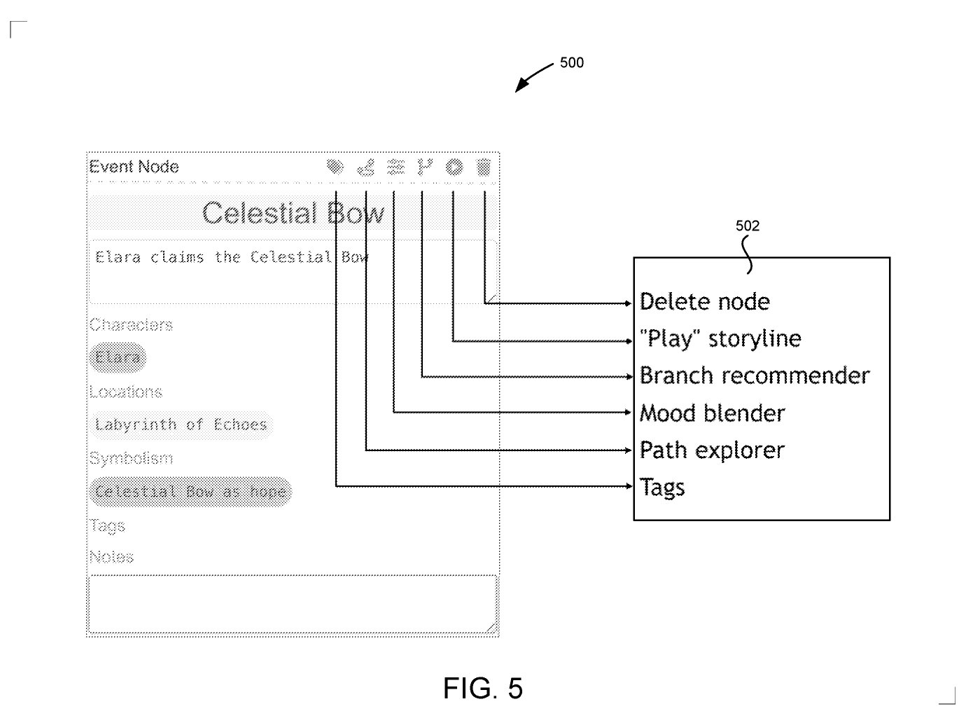

The authoring panel 404 displays a view of the narrative graph 220 including events and enables a selection and modification of events through direct input of event details, including event title, event description, character identifiers, location identifiers, and mood tags. The specific details of an event are discussed further below in conjunction with FIG. 5.

Returning to FIG. 3, the software application 104 generates diverging events 304. The software application 104 receives a request to create an event at a chosen point in the narrative graph 220 by the author, who desires to explore alternative plot paths. Specifically, the software application 104 receives a request as the author interacts with an event 500 (discussed further in detail directly below), and the storyline generation module 206 generates multiple sequential events. However, the author then decides the generated events are too similar to a preexisting storyline, and the software application 104 receives a request to delete the generated events. Subsequently, the software application 104 receives a request from the author to generate several diverging events. The software application 104 once again calls on the storyline generation module 206 to generate multiple diverging events, resulting in multiple new storyline paths.

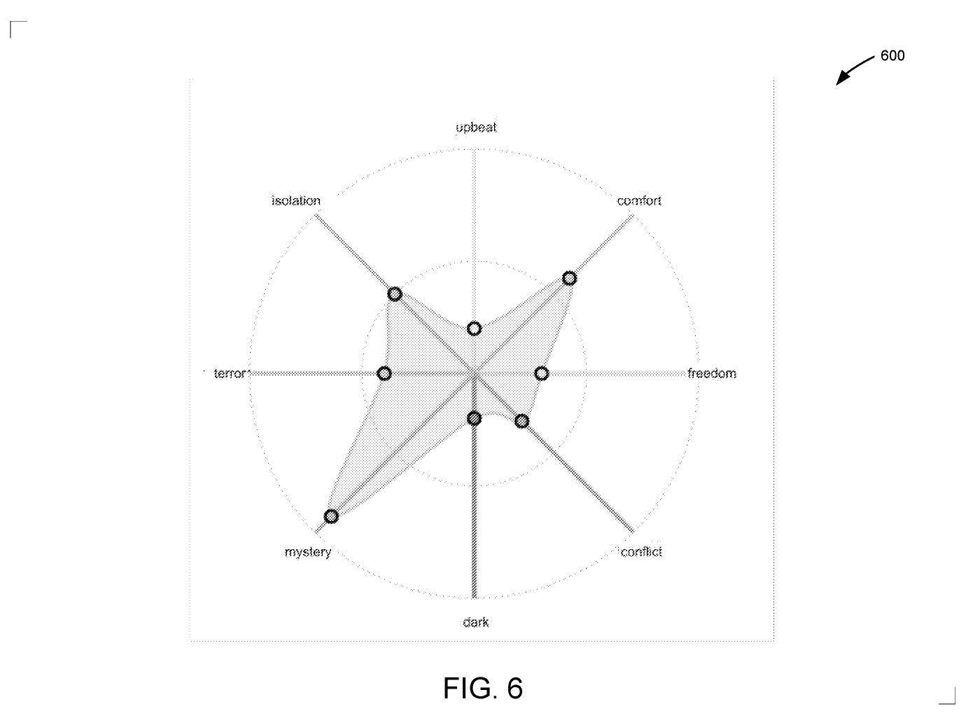

FIG. 5 is a detailed illustration of an event 500, according to various embodiments. The event 500 includes a title field and a description textbox for narrative detail. The event 500 can also include fields for character identifiers, location identifiers, symbolism tags, and a notes textbox for freeform annotations. The event 500 stores metadata for narrative time index, indicating where in the narrative graph 220 the event 500 is located with respect to other events, metadata indicating AI-generated or user-provided content, and mood tags assigned via a “mood blender” control, discussed further in conjunction with FIG. 6.

In some embodiments, the event 500 includes a control bar 502 at the top. The control bar 502 includes a “tags view” button, a “path explorer” button, a “mood blender” button, discussed further in conjunction with FIG. 6, a “branch recommender” button, a “play storyline” button, and a delete node button.

In some embodiments, the “play storyline” button enables a linear continuation of the storyline through one or more sequential event generation. Selection of the “play storyline” button invokes the storyline generation module 206 with context from the narrative graph 220. The storyline generation module 206 constructs a prompt that includes event sequence, mood metadata, character identifiers, and location identifiers. The generative AI model 112 can return one or more new sequential event proposals. The storyline generation module 206 parses proposals into new events 500 after continuity and consistency are assured via the continuity manager module 208.

In some embodiments, the “branch recommender” button enables the generation of diverging narrative directions. User selection of the “branch recommender” button invokes the storyline generation module 206 with context from the narrative graph 220, and the storyline generation module 206 constructs a prompt that requests multiple alternative continuations from the selected event 500.

The “mood blender” control enables specification of the emotional tone used for event generation and is discussed further in conjunction with FIG. 6.

The “path explorer” button enables the isolation and review of branching storylines containing a selected event 500. User selection of the “path explorer” button identifies all branching storylines, such as narrative paths, containing the selected event 500.

In operation, the software application 104 receives a selection by the author of a specific event 500, such as from the authoring panel 404. The software application 104 then receives a selection by the author of the “play storyline” button and generates sequential events 500. When the author disapproves of the generated events, the software application 104 receives and executes a request for deletion of the sequential events 500. The software application 104 then receives a selection from the author of the “branch recommender” button instead. For both the “play storyline” button selection and the “branch recommender” button selection, the storyline generation module 206 receives context for the selected event. In both instances, the storyline generation module 206 constructs a prompt for the generative AI model 112 specifying a continuation of (in the context of the “play storyline” button selection) and a divergence from (in the context of the “branch recommender” button selection) the selected event. The storyline generation module 206 then invokes the generative AI model 112 with the constructed prompt and receives a set of diverging event proposals. The storyline generation module 206 parses each event proposal into an event 500 and assigns metadata, such as character identifiers, location identifiers, and mood tags for each event. The continuity manager module 208 traverses the subgraph containing the selected source event and new event to identify potential continuity conflicts.

Returning to FIG. 3, the software application 104 receives a request to analyze thematic moods 306 of the newly generated diverging events. In some embodiments, the software application 104 can employ a thematic analysis tool, such as a “mood river” visualization 406 discussed below, to display the changing mood of storyline branches to the author. The “mood river” visualization 406 can show the author how moods (e.g., emotional tones) evolve across each storyline branch. Specifically, the “mood river” visualization 406 can display mood changes over narrative time. In some embodiments, summary bars highlight differences of primary or dominant moods within storyline branches. Through these visualizations, the software application 104 can allow for simple identification of branches dominated by similar or overly dark moods and notes where emotional variety is lacking.

In operation, the “mood river” visualization 406 is displayed in FIG. 4. The “mood river” visualization 406 displays mood tags from events 500 in selected narrative branches, such as branching storylines. Furthermore, for each branching storyline, the “mood river” visualization 406 displays a dominant mood and an associated intensity on the right-hand side, such as Mystery (0.61) or Dark (0.9), as shown in FIG. 4.

In some embodiments, the “mood river” visualization 406 assigns a distinct color to events when event 500 metadata indicates AI-generated or user-inputted content. Illustrated in FIG. 4, an orange event indicates user-inputted content, whereas a purple-colored event indicates AI-generated content. In some embodiments, a transition between two events in the “mood river” visualization 406 is assigned a specific color intensity for each average mood present between the two events 500.

Returning to FIG. 3, the software application 104 alters thematic moods 308 by receiving an input adjusting mood parameters via a mood blender 600. FIG. 6 is a detailed illustration of a mood blender 600, according to various embodiments.

In some embodiments, the mood blender 600 can be in the form of a radar chart. The radar chart can be labeled with eight axes: upbeat, comfort, freedom, conflict, dark, mystery, terror, and isolation. The mood blender 600 enables adjustment of each axis via a circular slider along the axis length.

In the context of the example workflow diagram 300, the software application 104 can receive input for the sliders to set new mood parameters. As the sliders are adjusted, the storyline generation module 206, the continuity manager module 208, and the verification module 210 receive the updated mood metadata for subsequent generation and verification requests. The updated mood metadata is incorporated when constructing prompts for the generative AI model 112. The verification module 210 evaluates existing narrative branches, such as branching storylines, against the updated mood metadata when invoked and can flag whether existing events match the desired mood in the location character overview 408, discussed further below.

Using the mood blender 600, the software application 104 can receive an adjustment by the author for the emotional composition (e.g., mood metadata) of a selected branch, reducing terror and isolation while increasing upbeat and comfort. This ensures that each branch delivers a distinct emotional arc and avoids thematic redundancy. The software application 104 can then recalculate and update the mood metadata to reflect the adjustments.

Returning to FIG. 3 example workflow diagram 300, the software application 104 can generate new endings 310 by receiving a selection of a terminal event 500 by the author in the authoring panel 404 and receiving a selection of the “play storyline” button with the refined mood metadata. For example, a tragic storyline branch may now yield a redemptive or bittersweet conclusion rather than a purely dark outcome.

In some embodiments, in order to generate new endings 310, the storyline generation module 206 constructs a prompt for the generative AI model 112 including the narrative context and newly updated mood metadata. The storyline generation module 206 invokes the generative AI model 112 and receives one or more proposed events 500. The storyline generation module 206 parses each proposed ending into an event 500 displayed in authoring panel 404.

Returning to FIG. 3 example workflow diagram 300, the software application 104 flags endings 312. Specifically, the continuity manager module 208 can traverse each generated storyline branch and apply continuity and consistency checks. The continuity manager module 208 flags conflicts such as character use after death, contradictory location assignments, or timeline violations. After generating the flags, the user interface 202 can display such flags through the location character overview 408, discussed directly below. The continuity manager 208 can additionally flag anticlimactic events and event sequences that lack dramatic tension, visualized in the location character overview 408.

Illustrated in FIG. 4, the location character overview 408 displays character presence across locations over narrative time for selected branches. In some embodiments, the location character overview 408 constructs a timeline representation that maps narrative time to a horizontal axis and location identifiers to vertical lanes. In some embodiments, the location character overview 408 highlights overlaps and inconsistencies in character location interactions shown with a specific color (for example, a pink highlight in FIG. 4). The software application 104 can use the location character overview 408 to identify to the author, for example, an anticlimactic resolution due to insufficient conflict.

Returning to FIG. 3, the example workflow diagram 300, the software application 104 alters endings 314. The software application 104 can receive inputs from the author, who is guided by the flags, for additional events 500 that enhance pacing and conflict. For example, an encounter that deepens the antagonist-protagonist struggle before the finale. The narrative graph 220 updates to include these revisions, leading to a more dynamic and satisfying narrative flow in the affected storyline branch.

The software application 104 can receive a request from the author to analyze story engagement 316. In operation, as defined by the author, the software application 104 can receive a "Storyline Engagement" metric, such as audience emotional investment in a cohesive narrative. The software application 104 can then invoke the verification module 210 to calculate "Storyline Engagement" scores for each storyline branch. In some embodiments, the software application 104 can visualize these "Storyline Engagement" scores, for example, via bars or color gradients. By comparing these scores, the software application 104 can allow the author to identify the most compelling storyline branches.

The verification module 210, invoked in step 316 for custom metric definitions, begins by accepting the specified metric name and the natural-language definition, such as audience emotional investment in a cohesive narrative. The verification module 210 then traverses the narrative graph 220 to extract the sequence of events 500 and associated contexts, such as characters, locations, and moods for each selected storyline branch. Using this information, the verification module 210 constructs a targeted prompt for the generative AI model 112, embedding the metric definition alongside the events. The generative AI model 112 processes the prompt and returns a normalized score, for example, between 0 and 1, as "Storyline Engagement" scores.

The verification module 210 parses the results and updates the user interface 202. In some embodiments, the right-hand side of the "mood river" visualization 406 can be updated to visualize the normalized score for each storyline branch. If a score falls below a user-defined threshold, the verification module flags the storyline branch for revision via the location character overview 408. As the software application 104 receives edits to the narrative graph 220, the verification module 210 can re-run the evaluation. Located in FIG. 4, the software application 104 can receive input from the author for the custom metric definition through a selection of the LLM checker button 410.

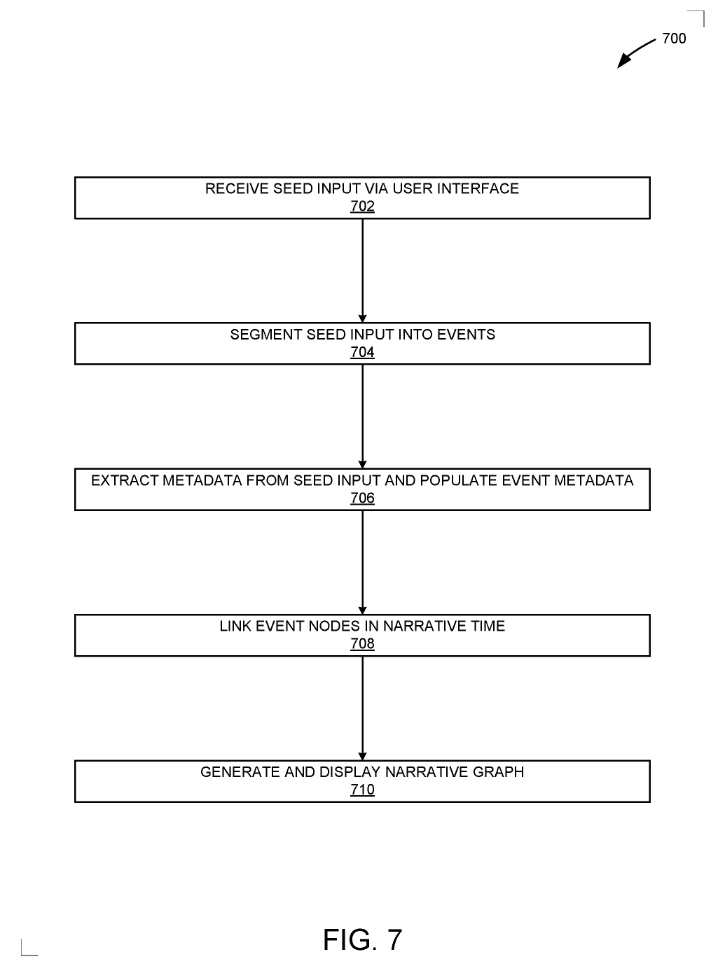

FIG. 7 sets forth a flow diagram of method steps for generating and displaying a narrative graph from a seed input according to various embodiments.

As shown in FIG. 7, the method 700 begins at step 702, where the software application 104 receives a seed input that can include narrative text that defines or describes an initial storyline, including one or more branching storylines or an outline describing one or more branching storylines (e.g., as described above in conjunction with FIGS. 1-6).

At step 704, the software application 104 segments the seed input into events. Specifically, the software application 104 utilizes narrative graph generation module 204 and the generative AI model 112 to identify discrete events within the seed input. The identified events in the seed input are converted into event data structures within narrative graph 220 for subsequent metadata extraction (e.g., as described above in conjunction with FIGS. 1-6).

At step 706, the software application 104 extracts metadata from the seed input and populates event data. Specifically, narrative graph generation module 204 identifies event information, narrative time index, characters, locations, and initial mood parameters and stores the information and metadata within the generated events (e.g., as described above in conjunction with FIGS. 1-6).

At step 708, the software application 104 links events in narrative time order. Specifically, narrative graph generation module 204 creates edges between events based on the narrative time index to represent sequential progressions and storyline branches (e.g., as described above in conjunction with FIGS. 1-6).

At step 710, the software application 104 generates and displays narrative graph 220 via user interface 202. User interface 202 enables visualization of the narrative graph 220 to editing, mood analysis, and branch exploration (e.g., as described above in conjunction with FIGS. 1-6).

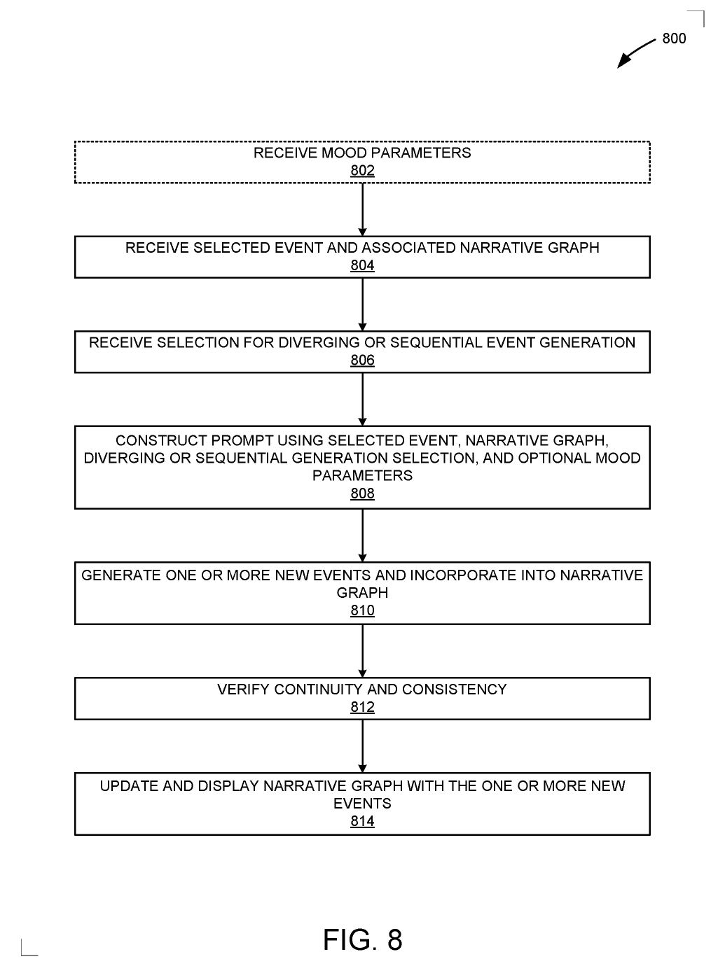

FIG. 8 sets forth a flow diagram of method steps for generating new events within a narrative graph according to various embodiments. As shown in FIG. 8, the method 800 begins at step 802.

At step 802, the software application 104 optionally receives mood parameters via input from a mood blender 600 to pass to storyline generation module 206 (e.g., as described above in conjunction with FIGS. 1-6).

At step 804, the software application 104 receives a selection of an event 500 and an associated narrative graph 220. Specifically, a user selection of an event 500 within the user interface 202 is passed along with the narrative graph 220 to storyline generation module 206 (e.g., as described above in conjunction with FIGS. 1-6).

At step 806, the software application 104 receives a selection for diverging or sequential event generation. Specifically, user selection of a "branch recommender" button or a "play storyline" button within a control bar 502 informs storyline generation module 206 which generation mode to invoke (e.g., as described above in conjunction with FIGS. 1-6).

At step 808, the storyline generation module 206 constructs a prompt for generative AI model 112 using the selected event, narrative graph 220, diverging or sequential generation selection, and optional mood parameters (e.g., as described above in conjunction with FIGS. 1-6).

At step 810, the software application 104 generates one or more new events 500. Specifically, the storyline generation module 206 invokes generative AI model 112 with the constructed prompt, parses the returned text into discrete events 500 with associated event information and metadata, and inserts the events 500 into the narrative graph 220 as diverging or sequential events 500 (e.g., as described above in conjunction with FIGS. 1-6).

At step 812, the software application 104 verifies continuity and consistency. Specifically, continuity manager module 208 applies rule-based checks to identify character-location conflicts, timeline violations, and coherence issues in newly generated events. The continuity manager 208 can then flag discontinuities associated with the narrative graph 220 (e.g., as described above in conjunction with FIGS. 1-6 and FIG. 9).

At step 814, the software application 104 updates and displays the narrative graph 220 with the one or more new events via user interface 202 (e.g., as described above in conjunction with FIGS. 1-6).

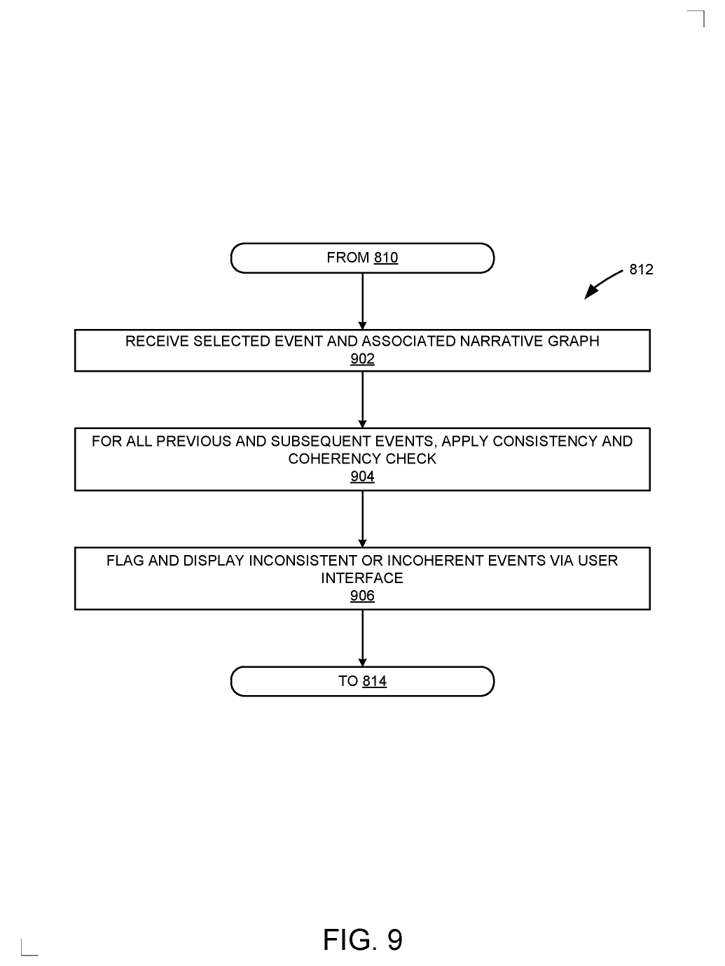

FIG. 9 sets forth a flow diagram of method steps for verifying continuity and consistency 812 of a narrative graph 220 after the addition, deletion, or modification of events 500 according to various embodiments. As shown in FIG. 9, the method 812 begins at step 902.

At step 902, the software application 104 receives a selection of an event 500 and an associated narrative graph 220. The selection of an event 500 can follow a deletion (in such cases, the preceding event 500 is selected), addition, or modification of an event 500. Software application 104 passes the selected event 500 and the narrative graph 220 to a verification module 210 (e.g., as described above in conjunction with FIGS. 1-6).

At step 904, the software application 104 applies consistency and coherency checks to all previous and subsequent events. Specifically, continuity manager module 208 traverses the preceding events up to the selected event, including the selected event and subsequent events, and adds the associated event information and metadata to the context window of generative AI model 112. The continuity manager module 208 then invokes generative AI model 112 to perform rule-based checks for character existence, location consistency, and narrative time ordering. Additionally, continuity manager module 208 can apply consistency analysis to detect issues such as rapid mood changes within a single storyline branch, inconsistent pacing, tension imbalances, and potentially anticlimactic events (e.g., as described above in conjunction with FIGS. 1-6).

At step 906, the software application 104 flags and displays inconsistent or incoherent events via user interface 202. Specifically, location-character overview 408 can visually indicate specific events 500 that exhibit continuity or coherence violations (e.g., as described above in conjunction with FIGS. 1-6).

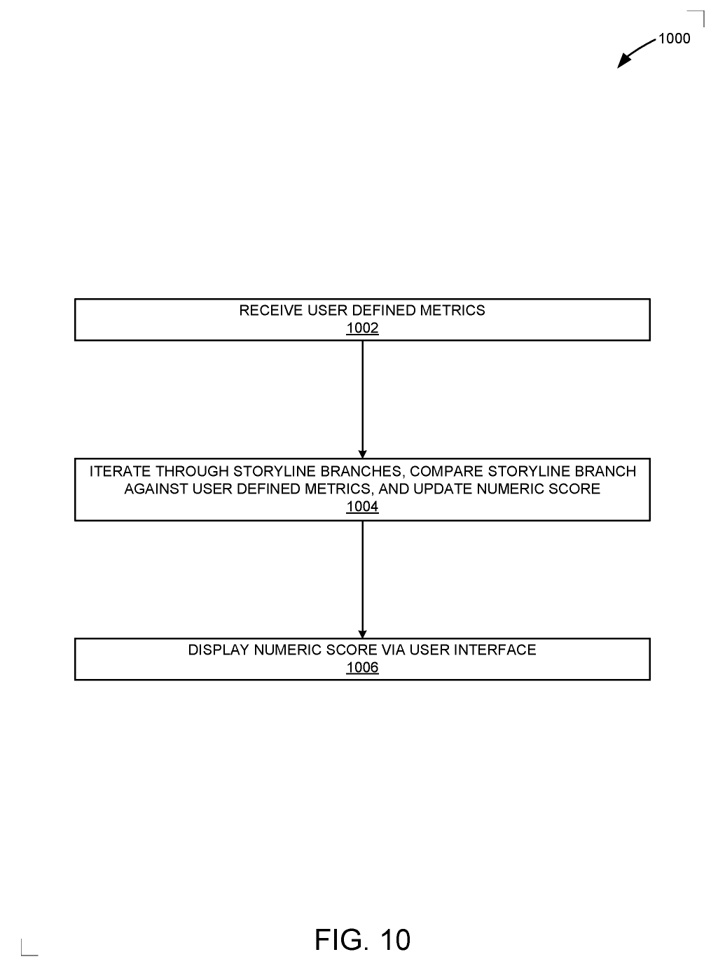

FIG. 10 sets forth a flow diagram of method steps for evaluating a narrative graph 220 based on user-defined metrics according to various embodiments. As shown in FIG. 10, the method 1000 begins at step 1002.

At step 1002, the software application 104 receives one or more user-defined metrics. Specifically, the user interface 202 can receive user-defined metrics from a user after selecting the LLM checker button 410. The user interface 220 can then pass the user-defined metrics to a verification module 210 (e.g., as described above in conjunction with FIGS. 1-6).

At step 1004, the software application 104 iterates through storyline branches, compares the storyline branch against the user-defined metrics, and updates a numeric score. Specifically, the verification module 210 aggregates event information and metadata for events 500 within each storyline branch, and adds the aggregated data to a context window of a generative AI model 112. For each storyline branch, the verification module 210 constructs a prompt combining the context window and user-defined metric definitions and invokes generative AI model 112 with the constructed prompt. The verification module 210 parses a response from the generative AI model 112 to extract a numeric score for each storyline branch (e.g., as described above in conjunction with FIGS. 1-6).

At step 1006, the software application 104 displays the numeric scores. Specifically, the "mood river" visualization 406 can render a bar chart or table of numeric scores alongside each storyline branch (e.g., as described above in conjunction with FIGS. 1-6).

### Computing Device Overview

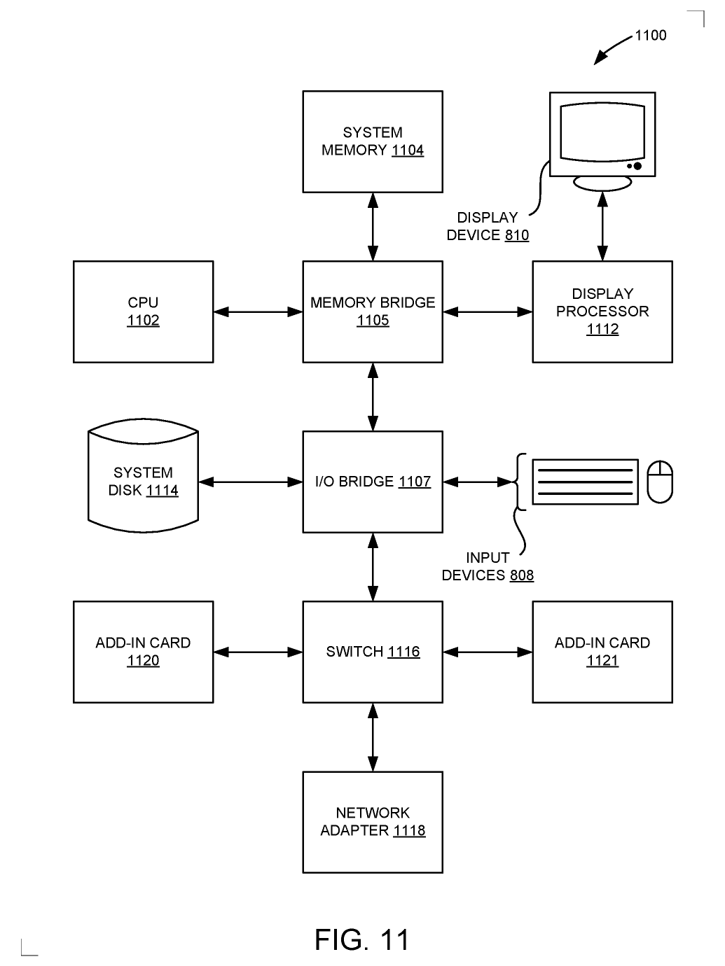

FIG. 11 is a more detailed illustration of a computing device that can implement the functionalities of the entities illustrated in FIG. 1, according to various embodiments. This Figure in no way limits or is intended to limit the scope of the various embodiments. In various implementations, system 1100 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 1100 may be coupled together to practice one or more aspects of the various embodiments.

As shown, system 1100 includes a central processing unit (CPU) 1102 and a system memory 1104 communicating via a bus path that may include a memory bridge 1105. CPU 1102 includes one or more processing cores, and, in operation, CPU 1102 is the master processor of system 1100, controlling and coordinating operations of other system components. System memory 1104 stores software applications and data for use by CPU 1102. CPU 1102 runs software applications and optionally an operating system. Memory bridge 1105, which may be, e.g., a Northbridge chip, is connected via a bus or other communication path (e.g., a HyperTransport link) to an I/O (input/output) bridge 1107. I/O bridge 1107, which may be, e.g., a Southbridge chip, receives user input from one or more user input devices 1108 (e.g., keyboard, mouse, joystick, digitizer tablets, touch pads, touch screens, still or video cameras, motion sensors, and/or microphones) and forwards the input to CPU 1102 via memory bridge 1105.

A display processor 1112 is coupled to memory bridge 1105 via a bus or other communication path (e.g., a PCI Express, Accelerated Graphics Port, or HyperTransport link); in one embodiment display processor 1112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 1104.

Display processor 1112 periodically delivers pixels to a display device 1110 (e.g., a screen or conventional CRT, plasma, OLED, SED or LCD based monitor or television). Additionally, display processor 1112 may output pixels to film recorders adapted to reproduce computer generated images on photographic film. Display processor 1112 can provide display device 1110 with an analog or digital signal. In various embodiments, one or more of the various graphical user interfaces described herein are displayed to one or more users via display device 1110, and the one or more users can input data into and receive visual output from those various graphical user interfaces.

A system disk 1114 is also connected to I/O bridge 1107 and may be configured to store content and applications and data for use by CPU 1102 and display processor 1112. System disk 1114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 1116 provides connections between I/O bridge 1107 and other components such as a network adapter 1118 and various add-in cards 1120 and 1121. Network adapter 1118 allows system 1100 to communicate with other systems via an electronic communications network, and may include wired or wireless communication over local area networks and wide area networks such as the Internet.

Other components (not shown), including USB or other port connections, film recording devices, and the like, may also be connected to I/O bridge 1107. For example, an audio processor may be used to generate analog or digital audio output from instructions and/or data provided by CPU 1102, system memory 1104, or system disk 1114. Communication paths interconnecting the various components in FIG. 11 may be implemented using any suitable protocols, such as PCI (Peripheral Component Interconnect), PCI Express (PCIE), AGP (Accelerated Graphics Port), HyperTransport, or any other bus or point-to-point communication protocol(s), and connections between different devices may use different protocols, as is known in the art.

In one embodiment, display processor 1112 incorporates circuitry optimized for graphics and video processing, including, for example, video output circuitry, and constitutes a graphics processing unit (GPU). In another embodiment, display processor 1112 incorporates circuitry optimized for general purpose processing. In yet another embodiment, display processor 1112 may be integrated with one or more other system elements, such as the memory bridge 1105, CPU 1102, and I/O bridge 1107 to form a system on chip (SoC). In still further embodiments, display processor 1112 is omitted and software executed by CPU 1102 performs the functions of display processor 1112.

Pixel data can be provided to display processor 1112 directly from CPU 1102. In some embodiments, instructions and/or data representing a scene are provided to a render farm or a set of server computers, each similar to system 1100, via network adapter 1118 or system disk 1114. The render farm generates one or more rendered images of the scene using the provided instructions and/or data. These rendered images may be stored on computer-readable media in a digital format and optionally returned to system 1100 for display. Similarly, stereo image pairs processed by display processor 1112 may be output to other systems for display, stored in system disk 1114, or stored on computer-readable media in a digital format.

Alternatively, CPU 1102 provides display processor 1112 with data and/or instructions defining the desired output images, from which display processor 1112 generates the pixel data of one or more output images, including characterizing and/or adjusting the offset between stereo image pairs. The data and/or instructions defining the desired output images can be stored in system memory 1104 or graphics memory within display processor 1112. In an embodiment, display processor 1112 includes 3D rendering capabilities for generating pixel data for output images from instructions and data defining the geometry, lighting shading, texturing, motion, and/or camera parameters for a scene. Display processor 1112 can further include one or more programmable execution units capable of executing shader programs, tone mapping programs, and the like.

Further, in other embodiments, CPU 1102 or display processor 1112 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 1102, display processor 1112, or one or more other processing devices or any combination of these different processors.

CPU 1102, render farm, and/or display processor 1112 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 1100 may be a robot or robotic device and may include CPU 1102 and/or other processing units or devices and system memory 1104. In such embodiments, system 1100 may or may not include other elements shown in FIG. 11. System memory 1104 and/or other memory units or devices in system 1100 may include instructions that, when executed, cause the robot or robotic device represented by system 1100 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 1104 is connected to CPU 1102 directly rather than through a bridge, and other devices communicate with system memory 1104 via memory bridge 1105 and CPU 1102. In other alternative topologies display processor 1112 is connected to I/O bridge 1107 or directly to CPU 1102, rather than to memory bridge 1105. In still other embodiments, I/O bridge 1107 and memory bridge 1105 might be integrated into a single chip. The particular components shown herein are optional; for instance, any number of add-in cards or peripheral devices might be supported. In some embodiments, switch 1116 is eliminated, and network adapter 1118 and add-in cards 1120, 1121 connect directly to I/O bridge 1107.

In sum, the disclosed embodiments set forth techniques for authoring branched narrative fictions (BNFs) through a method of generating, organizing, and visualizing branching storylines using user input data in a software application. In particular, the disclosed techniques provide a dynamic process for receiving a storyline from a user and generating a corresponding narrative graph using one or more generative AI models. Events in the narrative graph represent narrative events associated with an action, a character, and a location. A user can then select a specific event from which additional branching storylines can be developed further. Such development may involve extending storylines linearly or manually adding events, which supports real-time modifications to the narrative graph. Additionally, the software application provides visualizations and verification tools that assist in organizing storylines, adjusting moods associated with specific storyline branches, and analyzing narrative quality based on user-defined metrics.

At least one technical advantage of the disclosed techniques over prior approaches is the provision of a visual, intuitive, and interactive software platform that leverages generative artificial intelligence (AI) to facilitate organization, development, and exploration of branched narrative fictions. The software platform enables multiple branching storylines to be dynamically edited, rearranged, and analyzed in parallel. Such functionality is supported, in part, by a graph-based representation of branching structures – referred to as a narrative graph – that captures relationships among events, characters, locations, actions, and narrative outcomes. Maintenance and visualization of such relationships improves the ability to manage and navigate complex, branching storylines.

In addition to enhanced organizational capabilities, the disclosed techniques can reduce the time and effort required to author and revise branched narrative fiction by eliminating reliance on manual scripting or specialized markup languages. Instead, branching storylines can be generated and refined through direct manipulation of specific events, with generative suggestions accelerating the development process. The ability to generate and manage a larger number of narrative branches provides a broader range of options for each storyline, thereby contributing to higher-quality creative outputs. Use of narrative graphs further supports iterative refinement and enables validation of thematic structure and consistency across branching paths, thereby enhancing overall narrative coherence.
1. In some embodiments, a computer-implemented method for developing branched narrative fictions comprises receiving input data comprising narrative content; generating, via a generative artificial intelligence (AI) model, a narrative graph based on the input data, wherein the narrative graph comprises a plurality of events; receiving a selection of an event within the narrative graph; generating an updated version of the narrative graph based on the event; and displaying, via a user interface, a representation of the updated version of the narrative graph.
2. The computer-implemented method of clause 1, wherein each event included in the plurality of events comprises metadata that includes at least one of a character identifier, a location identifier, or one or more mood parameters.
3. The computer-implemented method of any of clauses 1-2, further comprising: receiving, via the user interface, one or more mood parameters associated with a portion of the narrative graph corresponding to a branching storyline; and generating one or more additional events based at least in part on the one or more mood parameters.
4. The computer-implemented method of any of clauses 1-3, wherein the user interface comprises a visualization panel that displays emotional tone evolution across branching storylines over narrative time.
5. The computer-implemented method any of clauses 1-4, further comprising: verifying a continuity of the updated version of the narrative graph by analyzing a consistency in character presence, location assignments, and narrative time ordering.
6. The computer-implemented method of any of clauses 1-5, wherein verifying continuity further comprises identifying one or more conflicts based on at least one of a use of a character after a defined endpoint, an inconsistent mood pacing, a location contradiction, or an anticlimactic transition.
7. The computer-implemented method of any of clauses 1-6, further comprising: evaluating a branch of the updated version of the narrative graph based on a user-defined metric.
8. The computer-implemented method of any of clauses 1-7, wherein the user-defined metric comprises a natural language definition of at least one of a narrative coherence or an audience engagement.
9. The computer-implemented method of any of clauses 1-8, wherein the user interface further displays a character-location timeline overview across narrative branches and highlights inconsistencies detected during continuity verification.
10. The computer-implemented method of any of clauses 1-9, wherein each event in the narrative graph includes metadata indicating whether narrative content associated with the event was user-provided or generated by the generative AI model.
11. In some embodiments, one or more non-transitory computer-readable media store instructions that, when executed by one or more processors, cause the one or more processors to perform the operations of receiving input data comprising narrative content; generating, via a generative artificial intelligence (AI) model, a narrative graph based on the input data, wherein the narrative graph comprises a plurality of events; receiving a selection of an event within the narrative graph; generating an updated version of the narrative graph based on the event; and displaying, via a user interface, a representation of the updated version of the narrative graph.
12. The one or more non-transitory computer-readable media of clause 11, wherein each event included in the plurality of events comprises metadata that includes at least one of a character identifier, a location identifier, or one or more mood parameters.
13. The one or more non-transitory computer-readable media of any of clauses 11-12, wherein the instructions further cause the one or more processors to receive user input specifying mood parameters and provide the mood parameters as input into the at least one generative AI model when generating the updated version of the narrative graph.
14. The one or more non-transitory computer-readable media of any of clauses 11-13, wherein the instructions further cause the one or more processors to verify continuity of the updated version of the narrative graph using at least one of rule-based or AI-based checks for at least one of temporal consistency, spatial consistency, or character consistency.
15. The one or more non-transitory computer-readable media of any of clauses 11-14, wherein the instructions further cause the one or more processors to: evaluate at least one branch of the narrative graph based on a user-defined metric; and display a score for the at least one branch of the narrative graph.
16. The one or more non-transitory computer-readable media of any of clauses 11-15, wherein the user interface displays a graphical representation of emotional tone progression for sequences of events within the narrative graph.
17. The one or more non-transitory computer-readable media of any of clauses 11-16, wherein the instructions further cause the one or more processors to associate each event included in the plurality of events with an indicator of whether the event was generated by the generative AI model or received as an input.
18. The one or more non-transitory computer-readable media of any of clauses 11-17, wherein the user interface includes a multi-axis mood blending control that adjusts emotional tone parameters provided to the generative AI model when generating the updated version of the narrative graph.
19. The one or more non-transitory computer-readable media of any of clauses 11-18, wherein the updated version of the narrative graph is generated by at least one of: extending the narrative graph with one or more user-defined events; generating one or more diverging events via the generative AI model; or generating one or more sequential events via the generative AI model.
20. In some embodiments, a computer system comprises one or more processors, and one or more non-transitory memories storing instructions that, when executed by the one or more processors, cause the computer system to: receive input data comprising narrative content; generate, via a generative artificial intelligence (AI) model, a narrative graph based on the input data, wherein the narrative graph comprises a plurality of events; receive a selection of an event within the narrative graph; generate an updated version of the narrative graph based on the event, and display, via a user interface, information associated with the updated version of the narrative graph.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for developing branched narrative fictions, the method comprising:
receiving input data comprising narrative content;
generating, via a generative artificial intelligence (AI) model, a narrative graph based on the input data, wherein the narrative graph comprises a plurality of events;
receiving a selection of an event within the narrative graph;
generating an updated version of the narrative graph based on the event; and
displaying, via a user interface, a representation of the updated version of the narrative graph.

2. The computer-implemented method of claim 1, wherein each event included in the plurality of events comprises metadata that includes at least one of a character identifier, a location identifier, or one or more mood parameters.

3. The computer-implemented method of claim 1, further comprising:
receiving, via the user interface, one or more mood parameters associated with a portion of the narrative graph corresponding to a branching storyline; and
generating one or more additional events based at least in part on the one or more mood parameters.

4. The computer-implemented method of claim 1, wherein the user interface comprises a visualization panel that displays emotional tone evolution across branching storylines over narrative time.

5. The computer-implemented method of claim 1, further comprising:
verifying a continuity of the updated version of the narrative graph by analyzing a consistency in character presence, location assignments, and narrative time ordering.

6. The computer-implemented method of claim 5, wherein verifying continuity further comprises identifying one or more conflicts based on at least one of a use of a character after a defined endpoint, an inconsistent mood pacing, a location contradiction, or an anticlimactic transition.

7. The computer-implemented method of claim 1, further comprising:
evaluating a branch of the updated version of the narrative graph based on a user-defined metric.

8. The computer-implemented method of claim 7, wherein the user-defined metric comprises a natural language definition of at least one of a narrative coherence or an audience engagement.

9. The computer-implemented method of claim 1, wherein the user interface further displays a character-location timeline overview across narrative branches and highlights inconsistencies detected during continuity verification.

10. The computer-implemented method of claim 1, wherein each event in the narrative graph includes metadata indicating whether narrative content associated with the event was user-provided or generated by the generative AI model.

11. One or more non-transitory computer-readable media storing instructions that, when executed by one or more processors, cause the one or more processors to perform operations comprising:
receiving input data comprising narrative content;
generating, via a generative artificial intelligence (AI) model, a narrative graph based on the input data, wherein the narrative graph comprises a plurality of events;
receiving a selection of an event within the narrative graph;
generating an updated version of the narrative graph based on the event; and
displaying, via a user interface, a representation of the updated version of the narrative graph.

12. The one or more non-transitory computer-readable media of claim 11, wherein each event included in the plurality of events comprises metadata that includes at least one of a character identifier, a location identifier, or one or more mood parameters.

13. The one or more non-transitory computer-readable media of claim 11, wherein the instructions further cause the one or more processors to receive user input specifying mood parameters and provide the mood parameters as input into the at least one generative AI model when generating the updated version of the narrative graph.

14. The one or more non-transitory computer-readable media of claim 11, wherein the instructions further cause the one or more processors to verify continuity of the updated version of the narrative graph using at least one of rule-based or AI-based checks for at least one of temporal consistency, spatial consistency, or character consistency.

15. The one or more non-transitory computer-readable media of claim 11, wherein the instructions further cause the one or more processors to:
evaluate at least one branch of the narrative graph based on a user-defined metric; and
display a score for the at least one branch of the narrative graph.

16. The one or more non-transitory computer-readable media of claim 11, wherein the user interface displays a graphical representation of emotional tone progression for sequences of events within the narrative graph.

17. The one or more non-transitory computer-readable media of claim 11, wherein the instructions further cause the one or more processors to associate each event included in the plurality of events with an indicator of whether the event was generated by the generative AI model or received as an input.

18. The one or more non-transitory computer-readable media of claim 11, wherein the user interface includes a multi-axis mood blending control that adjusts emotional tone parameters provided to the generative AI model when generating the updated version of the narrative graph.

19. The one or more non-transitory computer-readable media of claim 11, wherein the updated version of the narrative graph is generated by at least one of:
extending the narrative graph with one or more user-defined events;
generating one or more diverging events via the generative AI model; or
generating one or more sequential events via the generative AI model.

20. A computer system, comprising:
one or more processors; and
one or more non-transitory memories storing instructions that, when executed by the one or more processors, cause the computer system to:
receive input data comprising narrative content;
generate, via a generative artificial intelligence (AI) model, a narrative graph based on the input data, wherein the narrative graph comprises a plurality of events;
receive a selection of an event within the narrative graph;
generate an updated version of the narrative graph based on the event; and
display, via a user interface, information associated with the updated version of the narrative graph.
